(19) United States
(12) Patent Application Publication
(10) Pub. No.: US 2008/0071848 A1
(43) Pub. Date: Mar. 20, 2008

(54) In-Place Radix-2 Butterfly Processor and Method

(75) Inventors: Vijayavardhan BAIREDDY, Kondapak (IN); Himamshu Gopalakrishna KHASNIS, Bangalore (IN); Rajesh Hargovind MUNDHADA, Amaravati (IN); Georgios GINIS, San Mateo, CA (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/849,881

(22) Filed: Sep. 4, 2007

Related U.S. Application Data
(60) Provisional application No. 60/825,672, filed on Sep. 14, 2006.

(51) Int. Cl. G06F 17/14

(52) U.S. Cl. 708/404

(57) ABSTRACT

A butterfly processor architecture including a single high speed multiplier unit and two adder/subtracter units structured to efficiently perform radix-2 decimation-in-time (DIT) butterfly operations is disclosed. The computations for windowing operations, FFT operations, and IFFT operations may be realized in terms of butterfly operations. Therefore, the butterfly processor architecture may be used to perform the computations of a plurality of signal processing operations. The butterfly operations may be performed in-place whereby the results of each operation may be stored in the same location in memory where the inputs for each operation were retrieved. Performing the butterfly operations in-place ensures that the memory may be big enough to hold one frame of data. The butterfly processor architecture may also use scaling elements for implementation of a dynamic scaling algorithm which may reduce the precision requirements of intermediate results when performing signal processing operations and may reduce the data word length.

### CROSS-REFERENCE TO RELATED APPLICATIONS

This application claims priority to U.S. Provisional Application No. 60/825,672, filed Sep. 14, 2006, entitled “64-4096 Point FFT/IFFT/Windowing Processor for Multi-Standard ADSL/VDSL Applications,” which is incorporated by reference herein as if reproduced in fill below.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Applications such as asymmetric digital subscriber line (ADSL) and very high data rate subscriber line (VDSL) may implement various signal processing operations such as inverse fast Fourier transform (IFFT) operations, fast Fourier transform (FFT) operations, and windowing operations. With multi-standard digital subscriber line (DSL) applications, the FFT and IFFT operations may be performed for different FFT and IFFT sizes depending on the standard. Similarly, windowing operations may be performed with variable window lengths depending on the standard. Implementing each of these signal processing operations with a programmable digital signal processor may result in large power consumption and processing capability requirements. Similarly, implementing each of these signal processing operations as separate hardware in a signal processing chain may also result in a large area, power consumption, and processing capability requirements. As the FFT and the IFFT sizes increase and the window length increases, the processing load required to perform each of these operations may similarly increase. Also, in some multi-standard DSL applications, dual time domain equalization (TEQ) paths may be provided. Each TEQ path may have windowing and FFT operations in the signal processing chain, resulting in redundant hardware for each TEQ path.

FIG. 10 illustrates a prior art implementation of a signal processing architecture for performing FFT and windowing operations in terms of butterfly operations.

### SUMMARY

In one aspect, the disclosure includes a system comprising a memory and a processor configured to perform multiple iterations of in-place decimation-in-time radix-2 butterfly operations on a sequence of input data. The processor executes one of a plurality of signal processing operations including a fast Fourier transform and inverse fast Fourier transform. For each of the multiple iterations, the processor receives a first input from a first location in the memory and receives a second input from a second location in the memory. The processor performs a radix-2 butterfly operation of the first input and the second input to generate a first output and a second output. The first output is stored in the first location in the memory and the second output is stored in the second location in the memory.

In another aspect, the disclosure includes a method of performing an inverse fast Fourier transform. The method includes executing a pre-processing operation on a sequence of frequency domain data. The frequency domain data is expressed as: X(i)=Xₑ(i)+W_{N}ⁱ*Xₒ(i), where i is an integer, X(i) is the sequence of frequency domain data, Xₑ(i) is even data in the sequence of frequency domain data, W_{N}ⁱ=e^{-j2πi/N} is a twiddle factor, N is a number of samples of data in the sequence of frequency domain data, and Xₒ(i) is odd data in the sequence of frequency domain data. The pre-processing operation transforms the sequence of frequency domain data to a format expressed as: Y(i)=Xₑ^{*}(i)+jXₒ^{*}(i), where Y(i) is the transformed sequence of frequency domain data, Xₑ^{*}(i) is the complex conjugate of even data in the sequence of frequency domain data, j is a representation of an imaginary number \sqrt{−1}, and Xₒ^{*}(i) is the complex conjugate of odd data in the sequence of frequency domain data. The method also includes executing a fast Fourier transform on the transformed sequence of frequency domain data to generate the inverse fast Fourier transform of the sequence of frequency domain data. The inverse fast Fourier transform is stored.

In a third aspect, the disclosure includes a signal processor. The signal processor comprises a multiplier configured to multiply first inputs to the signal processor with a multiplication factor to generate a first output. The signal processor also comprises an adder configured to add second inputs to the signal processor with the first output to generate a second output. Further, the signal processor comprises a subtracter configured to subtract the first output from the second inputs to generate a third output. The signal processor executes one of a plurality of signal processing operations including a fast Fourier transform, an inverse fast Fourier transform, and a time domain windowing utilizing the multiplier, the adder, and the subtracter.

These and other features and advantages will be more clearly understood from the following detailed description taken in conjunction with the accompanying drawings and claims.

### BRIEF DESCRIPTION OF THE DRAWINGS

For a more complete understanding of the disclosure and the advantages thereof, reference is now made to the following brief description, taken in connection with the accompanying drawings and detailed description, wherein like reference numerals represent like parts.

FIG. 1 illustrates an exemplary functional block diagram of a digital subscriber line (DSL) signal processing chain according to an embodiment of the disclosure.

FIG. 2A illustrates an exemplary functional block diagram of a butterfly operation according to an embodiment of the disclosure.

FIG. 2B illustrates a simplified notation of the butterfly operation according to an embodiment of the disclosure.

FIG. 3 illustrates an exemplary functional block diagram of an in-place radix-2 butterfly operation according to an embodiment of the disclosure.

FIG. 4 illustrates an exemplary functional block diagram of a butterfly processor according to an embodiment of the disclosure.

FIG. 5A illustrates an exemplary processing sequence including a time domain windowing operation and a FFT operation according to an embodiment of the disclosure.

FIG. 5B illustrates an exemplary processing sequence including an IFFT operation and a time domain windowing operation according to an embodiment of the disclosure.

FIG. 6 illustrates exemplary butterfly operations for an eight-point FFT operation according to an embodiment of the disclosure.

FIG. 7A illustrates an exemplary functional block diagram for performing the post-processing operation according to an embodiment of the disclosure.

FIG. 7B illustrates an exemplary functional block diagram of a first butterfly operation for performing the post-processing operation according to an embodiment of the disclosure.

FIG. 7C illustrates an exemplary functional block diagram of a second butterfly operation for performing the post-processing operation according to an embodiment of the disclosure.

FIG. 8A illustrates an exemplary functional block diagram for performing the pre-processing operation according to an embodiment of the disclosure.

FIG. 8B illustrates an exemplary functional block diagram of a first stage butterfly operation for performing the pre-processing operation according to an embodiment of the disclosure.

FIG. 8C illustrates an exemplary functional block diagram of a second stage butterfly operation for performing the pre-processing operation according to an embodiment of the disclosure.

FIG. 9A illustrates a windowing operation according to an embodiment of the disclosure.

FIG. 9B illustrates an exemplary functional block diagram for performing the windowing operation according to an embodiment of the disclosure.

FIG. 9C illustrates an exemplary functional block diagram of a first stage butterfly operation for performing the windowing operation according to an embodiment of the disclosure.

FIG. 9D illustrates an exemplary functional block diagram of a second stage butterfly operation for performing the windowing operation according to an embodiment of the disclosure.

FIG. 10 illustrates an exemplary functional block diagram of a prior art implementation of a butterfly processor.

### DETAILED DESCRIPTION

It should be understood at the outset that although an exemplary implementation of one embodiment of the disclosure is illustrated below, the system may be implemented using any number of techniques, whether currently known or in existence. The disclosure should in no way be limited to the exemplary implementations, drawings, and techniques illustrated below, including the exemplary design and implementation illustrated and described herein, but may be modified within the scope of the appended claims along with their full scope of equivalents.

In communication systems, such as modems for asymmetric digital subscriber line (ADSL) and very high data rate subscriber line (VDSL), many signal processing operations may be used. For example, an ADSL modem or a VDSL modem may utilize a time domain windowing operation, a fast Fourier transform (FFT) operation, and an inverse fast Fourier transform (IFFT) operation in a signal processing chain. Hardware optimization may be achieved with a processor architecture that balances processor area, power consumption of the processor, and processing capability requirements of the processor. Hardware optimization in communication systems may be accomplished by using the same processor architecture for performing a plurality of signal processing operations. For example, the same processor architecture may perform the time domain windowing operation, the FFT operation, and the IFFT operation.

Disclosed herein is a butterfly processor architecture that uses a single high speed multiplier unit and two adder/subtracter units that are structured to efficiently execute radix-2 decimation-in-time (DIT) butterfly operations. The computations for windowing operations, FFT operations, and IFFT operations may be realized in terms of butterfly operations and hence the butterfly processor architecture may be used to perform the computations of a plurality of signal processing operations. Using the butterfly processor architecture, the throughput may only be limited by read and write operations to memory for each butterfly operation. The butterfly operations may be performed in-place whereby the results of each operation may be stored in the same location in memory where the inputs for each operation were retrieved. Performing the butterfly operations in-place ensures that the memory may be big enough to hold one frame of data. The butterfly processor architecture may also use scaling elements for implementation of a dynamic scaling algorithm. The dynamic scaling algorithm may reduce the precision requirements of intermediate results when performing the windowing operations, FFT operations, or IFFT operations and hence may reduce the data word length in the memory.

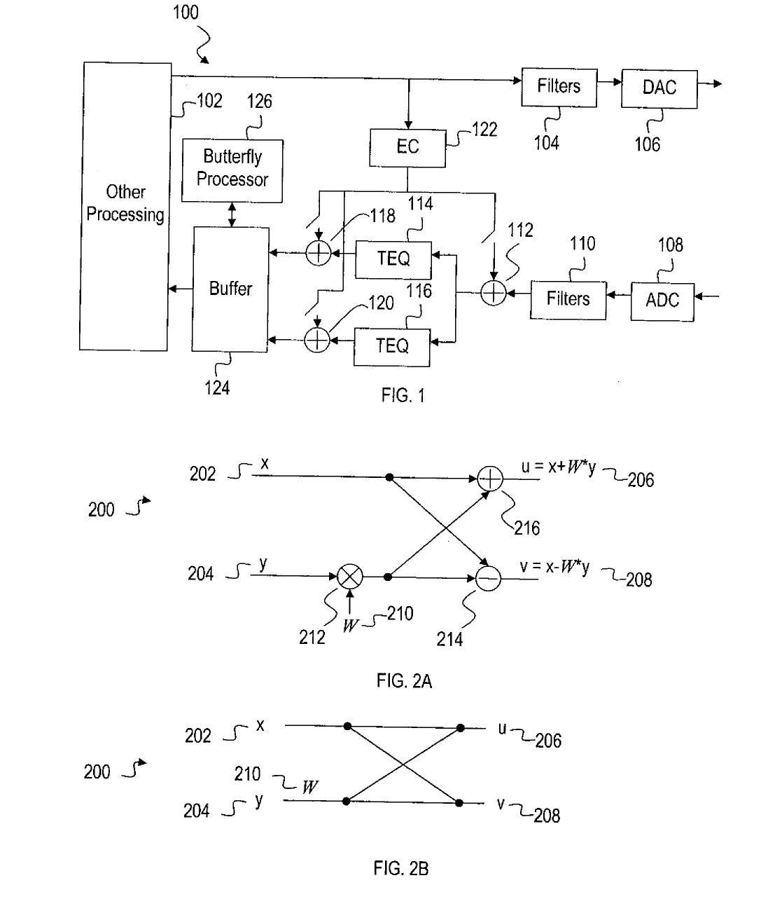

FIG. 1 illustrates an exemplary functional block diagram of a multi-standard digital subscriber line (DSL) signal processing chain 100 according to an embodiment of the disclosure. The signal processing chain 100 may include various other processing 102 that may be used to generate data, interpret data, or perform other processing operations, for example. Data from the other processing may be provided to one or more filters 104 and a digital-to-analog converter (DAC) 106 for outputting data from the signal processing chain 100.

Similarly, data may be received to the signal processing chain 100 through an analog-to-digital converter (ADC) 108 and one or more filters 110 to an adder unit 112. From the adder unit 112, the signal processing chain 100 may split into dual time domain equalization (TEQ) paths with a TEQ 114 and a TEQ 116. The TEQ 114 may output data to the adder unit 118 and the TEQ 116 may output data to the adder unit 120. The signal processing chain 100 includes a feedback loop from the other processing 102 to an echo cancellation (EC) unit 122. The EC unit 122 may provide data to one or more of the adder unit 112, the adder unit 118, or the adder unit 120 to perform echo cancellation. Each of the adder unit 118 and the adder unit 120 provide data to a buffer 124 from the dual TEQ paths.

The buffer 124 may communicate with a butterfly processor 126 for performing various signal processing operations. For example, the butterfly processor 126 may perform windowing operations, FFT operations, and IFFT operations on the data stored in the buffer 124. The butterfly processor 126 may be programmable to perform the windowing, FFT, and IFFT operations on samples in the range of around 64-4096 or more real samples. The buffer 124 may supply data processed by the butterfly processor 126 to the other processing 102 to be interpreted or have other processing operations performed, for example.

FIG. 2A illustrates an exemplary functional block diagram of a butterfly operation 200 according to an embodiment of the disclosure. The butterfly operation 200 receives an input x 202 and an input y 204 and a multiplication factor W 210. The butterfly operation 200 produces an output u 206 and an output v 208 using a multiplier unit 212, a subtracter unit 214, and an adder unit 216. The butterfly operation 200 uses the multiplier unit 212 to generate a product of the input y 204 and the multiplication factor W 210. The butterfly operation 200 generates the output u 206 as a sum of the input x 202 and the product and generates the output v 208 as a difference between the input x 202 and the product. Each of the multiplier unit 212, the subtracter unit 214, and the adder unit 216 may perform their respective operations on complex numbers. Therefore, the butterfly operation 200 may perform a series of complex multiplications and additions that compute the following:

u=x+W*y (1)

v=x−W*y (2)

where u, v, W, x, and y may be complex numbers. In FFT and IFFT operations, the multiplication factor W 210 is sometimes referred to as a twiddle factor that may be a complex number expressed as W_{N}ⁱ=e^{-j2πi/N}.

FIG. 2B illustrates a simplified notation of the butterfly operation 200 according to an embodiment of the disclosure. The simplified notation includes the input x 202, the input y 204, the multiplication factor W, the output u 206, and the output v 208. Rather than depicting each of the multiplier unit 212, the subtracter unit 214, and the adder unit 216, the simplified notation of the butterfly operation 200 is depicted with the two crossing lines as illustrated in FIG. 2B. As described in more detail below, various signal processing operations may be performed in terms of butterfly operations.

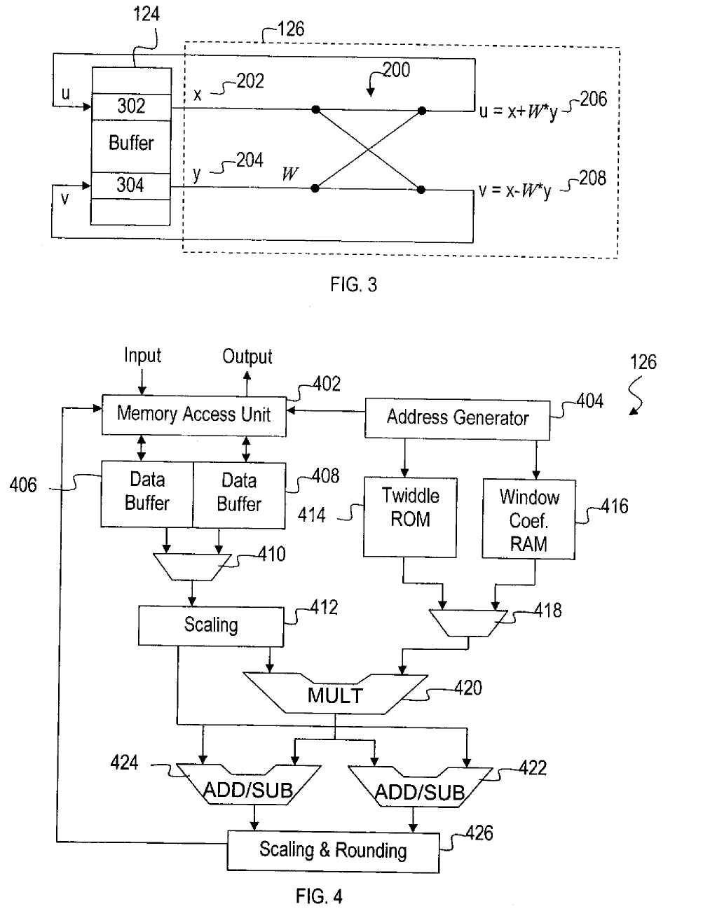

FIG. 3 illustrates an exemplary functional block diagram of an in-place radix-2 butterfly operation according to an embodiment of the disclosure. The in-place radix-2 butterfly operation includes the buffer 124 and the butterfly processor 126. The butterfly processor 126 is configured to perform the butterfly operation 200 on two inputs read from the buffer 124. For example, the butterfly processor 126 may retrieve the input x 202 from an address 302 of the buffer 124 and retrieve the input y 204 from an address 304 of the buffer 124. The butterfly processor 126 may perform the butterfly operation 200 to generate the output u 206 and the output v 208. The butterfly processor 126 may then store the output u 206 in the buffer 124 at the address 302 and store the output v 208 in the buffer 124 at the address 304.

With the in-place radix-2 butterfly operation, the results of each operation may be written back into the same location in the buffer 124 that the inputs were retrieved from. Using an in-place radix-2 butterfly operation may ensure that the data buffer 124 may be large enough to hold a frame of data. In a dual TEQ path implementation, the buffer 124 may be large enough for two frames of data. Each TEQ path may store data in one of two logical or physical partitions of the buffer 124. For example, with a physical partition, the buffer 124 may comprise two physical buffers, each configured to store data for one of the dual TEQ paths. One skilled in the art will recognize that the output u 206 may be stored in the buffer 124 at the address 304 and the output v 208 may be stored in the buffer 124 at the address 302. Further, one skilled in the art will recognize that one or both of the output u 206 and the output v 208 may not be stored in the buffer 124.

FIG. 4 illustrates an exemplary functional block diagram of the butterfly processor 126 according to an embodiment of the disclosure. The butterfly processor 126 may include a memory access unit 402 for reading inputs from the buffer 124 and storing outputs to the buffer 124. The memory access unit 402 may communicate with the buffer 124 in accordance with addresses generated by an address generator 404. For example, the memory access unit 402 may read data in the buffer 124 from an address generated by the address generator 404. Similarly, the memory access unit 402 may write data in the buffer 124 to an address generated by the address generator 404.

Input data read from the buffer 124 by the memory access unit 402 may be stored in a data buffer 406 or a data buffer 408. Each of the data buffer 406 and the data buffer 408 may be a one-frame data buffer. While the butterfly processor 126 operates on the data in one of the data buffer 406 or the data buffer 408, the input for the next signal processing operation may be stored in the other of the data buffer 406 or the data buffer 408. The address generator 404 may generate addresses for retrieving the appropriate input for the operations from one of the data buffer 406 or the data buffer 408.

A multiplexer 410 may select which of the data buffer 406 or the data buffer 408 to read data from for processing. The multiplexer 410 may provide the data to a scaling unit 412. The scaling unit 412 may shift input data to the right by a variable number of bits and round the result. For example, the scaling unit 412 may shift input to the right by one bit to perform a divide-by-two operation. The scaling unit 412 may also simply pass data through without shifting the input data. The scaling unit 412 may provide input data corresponding to the input y 204 in the butterfly operation 200 to a multiplier 420. The scaling unit 412 may also provide input data corresponding to the input x 202 in the butterfly operation 200 to each of an adder/subtracter 424 and an adder/subtracter 422.

The butterfly processor 126 may include or have access to a memory 414. The memory 414 may be a read-only memory (ROM) for storing twiddle factors used in performing FFT and IFFT operations. The butterfly processor 126 may also include or have access to a memory 416. The memory 416 may be a random access memory (RAM) for storing window coefficients used in time domain windowing operations. Each of the memory 414 and memory 416 may provide data to a multiplexer 418 in accordance with addresses generated by the address generator 404.

The multiplexer 418 may select which data to provide to the multiplier 420. For example, when utilizing the butterfly processor 126 to perform a FFT or an IFFT operation, the multiplexer 418 may select a twiddle factor supplied by the memory 414. Similarly, when utilizing the butterfly processor 126 to perform a time domain windowing operation, the multiplexer 418 may select a window coefficient supplied by the memory 416.

The multiplier 420 may multiply the input supplied by the scaling unit 412 and the twiddle factor or the window coefficient supplied by the multiplexer 418. The output from the multiplier 420 may be supplied to each of the adder/subtracter 424 and the adder/subtracter 422. The adder/subtracter 424 and the adder/subtracter 422 may perform an addition or subtraction operation on the input provided by the scaling unit 412 and the input provided by the multiplier 420. As described above, the butterfly processor 126 includes the multiplier 420, the adder/subtracter 424, and the adder/subtracter 422 that may be used to perform the butterfly operation 200 on data input from the buffer 124 through the memory access unit 402.

Each of the adder/subtracter 422 and the adder/subtracter 424 may supply their outputs to a scaling and rounding unit 426. The scaling and rounding unit 426 may shift input data to the right by a variable number of bits and round the result. For example, the scaling and rounding unit 426 may shift input to the right by one bit to perform a divide-by-two operation. The scaling and rounding unit 426 may also simply pass data through without shifting the input data.

The scaling unit 412 and the scaling and rounding unit 426 may be used to perform a dynamic scaling algorithm that may reduce the precision requirements of intermediate results when performing the windowing operations, FFT operations, or IFFT operations and hence may reduce the data word length in the buffer 124. Theoretically, the amplitude of the output of an FFT operation can scale up to 4096×\sqrt{2} for a 4096-point FFT, the precision growing with each stage of the FFT. The growth of precision may necessitate additional bits, increased precision of computation elements, and larger memory sizes.

The dynamic scaling algorithm performed by the scaling unit 412 and the scaling and rounding unit 426 may be used to limit the maximum value possible at a butterfly stage output to 1+\sqrt{2}. In an embodiment, the scaling and rounding unit 426 may utilize the dynamic scaling technique described U.S. Pat. No. 6,137,839, to Mannering et. al., which is incorporated by reference herein as if reproduced in full below. For example, the dynamic scaling algorithm may examine, at each butterfly stage, the maximum overflow seen in the previous stage. The maximum overflow seen in the previous stage may be used to determine the scaling of inputs of the current stage at the scaling unit 412. The accumulated scaling from previous stages may optionally be undone at the end of the FFT/IFFT operation with the scaling and rounding unit 426, or passed on to the next stage along with the data. The precision may be chosen to provide quantization noise power less than around −86 dBm.

The output from the scaling and rounding unit 426 may be supplied to the memory access unit 402 such that the results of each butterfly operation may be written back into the same location in the buffer 124 that the inputs were retrieved from. Therefore, the butterfly processor 126 may operate to perform an in-place radix-2 butterfly operation. The butterfly processor 126 may perform multiple iterations of the in-place radix-2 butterfly operation to perform various signal processing operations, as described in more detail below.

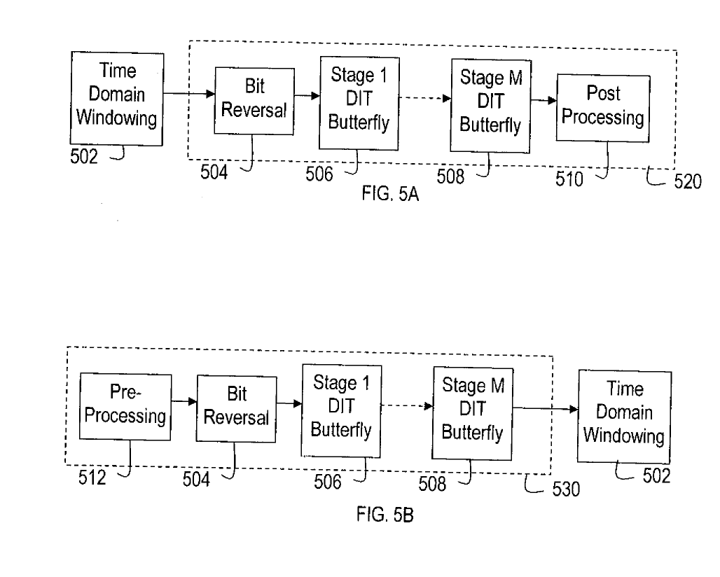

FIG. 5A illustrates an exemplary processing sequence including a time domain windowing block 502 and a FFT block 520 according to an embodiment of the disclosure. The FFT block 520 includes a bit reversal block 504, a stage 1 decimation-in-time (DIT) radix-2 butterfly block 506 through a stage M DIT radix-2 butterfly block 508, and a post processing block 510. The time domain windowing block 502 may be used to minimize edge effects that may lead to spectral leakage and thereby increase the spectral resolution of the frequency-domain. The bit-reversal block 504 provides the proper bit ordering for enabling a DIT Cooley-Turkey FFT. Each of the stage 1 DIT radix-2 butterfly block 506 through the stage M DIT radix-2 butterfly block 508 may perform (2^{M})/2 butterfly operations where M is the number of butterfly stages needed to perform a 2^{M}-point FFT. The post processing block 510 may transform the DIT Cooley-Turkey FFT data Y(k) received from the stage M DIT radix-2 butterfly block 508 to FFT data X(k) as described in more detail below.

FIG. 5B illustrates an exemplary processing sequence including an IFFT block 530 and the time domain windowing block 502 according to an embodiment of the disclosure. The IFFT block 530 includes a pre-processing block 512, the bit reversal block 504, and the stage 1 DIT radix-2 butterfly block 506 through the stage M DIT radix-2 butterfly block 508. The pre-processing block 512 may pre-process frequency domain data such that an IFFT operation may be realized through a FFT operation. As shown in FIG. 5A and FIG. 5B, the IFFT block 530 includes a common processing sequence as the FFT block 520. Namely, the bit reversal block 504 and the stage 1 DIT radix-2 butterfly block 506 through the stage M DIT radix-2 butterfly block 508 may be similarly executed in each of the IFFT block 530 and the FFT block 520. Each of the time domain windowing block 502, the blocks of the FFT block 520, and the blocks of the IFFT block 530 and their implementation in terms of butterfly operations are described in more detail below.

As described above, the FFT block 520 may perform a DIT Cooley-Turkey FFT operation. A sequence of data may be decomposed into a complex sum of two data subsequences comprised of even and odd data subsequences, respectively. That is, for N real samples x(n) for n=0, 1, . . . , N-1, rather than performing N FFT operations, the N real samples may be converted into N/2 complex samples y(k) as shown below:

y(0)=x(0)+jx(1) (3)

y(1)=x(2)+jx(3) (4)

and so on, where y(k) may generally be expressed as:

$$y ( k ) = x ( 2 k ) + jx ( 2 k + 1 ) , where k = 0 , 1 , … , ( \frac{N}{2} ) - 1. \qquad ( 5 )$$

As shown in equation (5), the N/2 complex samples y(k) may be a complex sum of the even samples and the odd samples of the N real samples. Therefore, rather than performing N FFT operations, only N/2 complex FFT operations may be performed.

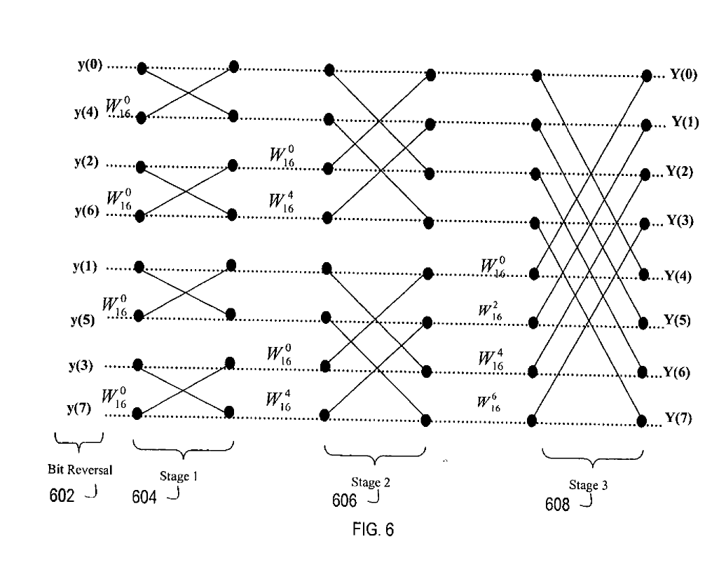

FIG. 6 illustrates exemplary stages of butterfly operations for an eight-point FFT operation according to an embodiment of the disclosure. The eight-point FFT operation may be a DIT Cooley-Turkey FFT operation performed on sixteen real samples x(n), for n=0, 1, . . . , 15 where N=16. The sixteen real samples x(n) may be decomposed into eight complex samples y(k)=x(2k)+jx(2k+1), for k=0, 1, . . . 7, as described above.

As shown in FIG. 5A, the FFT block 520 may include the bit reversal block 504. In FIG. 6, a bit reversal stage 602 represents an exemplary result of the bit reversal block 504. For example, at the bit reversal stage 602, the eight complex samples, y(k), of input may be paired to create four pairs of input data. A first pair of input data may include input y(0) and input y(4), a second pair of input data may include input y(2) and input y(6), and so on. The results shown in the bit reversal stage 602 may be performed by the address generator 404 in the bit reversal block 504. For example, the address generator 404 may generate the appropriate addresses for the data buffer 406 or the data buffer 408 to retrieve the appropriate data for each pair of input.

The FFT block 520 may also include the stage 1 DIT radix-2 butterfly block 506 through the stage M DIT radix-2 butterfly block 508. For performing an N/2-point DIT FFT operation on a sequence of N real samples, the number of stages of DIT radix-2 butterfly operations performed may be

$$M = {log}_{2} ( \frac{N}{2} ) .$$

### As discussed above, each of the stages of DIT radix-2 butterfly operations may perform

$$( {2}^{M} ) / 2 = ( \frac{N}{4} )$$

butterfly operations. For the exemplary stages of butterfly operations shown in FIG. 6, M=3 where each stage of butterfly operations includes four butterfly operations.

At a stage 1 butterfly operation 604, four butterfly operations are performed, one for each pair of input y(k). For example, a butterfly operation may be performed on the input y(0) and the input y(4) with a twiddle factor W₁₆⁰. Similarly, a stage 2 butterfly operation 606 may perform four butterfly operations on different pairs of the results of the stage 1 butterfly operation 604 with the appropriate twiddle factors. Finally, a stage 3 butterfly operation 608 may perform four butterfly operations on different pairs of the results of the stage 2 butterfly operation 606 with the appropriate twiddle factors to generate a FFT Y(k) for each of the inputs y(k). The butterfly processor 126 may operate to successively perform each of the four butterfly operations for each stage of butterfly operations. Therefore, the butterfly processor 126 iteratively performs

$$M * ( \frac{N}{4} )$$

butterfly operations to accomplish an

$$( \frac{N}{2} )$$

-point FFT operation.

The results from the stage I DIT radix-2 butterfly block 506 through the stage M DIT radix-2 butterfly block 508 may be expressed as:

$$\begin{matrix}DFT [ y ( n ) ] = Y ( k ) = {Y}_{r} ( k ) + {jY}_{i} ( k ) , & ( 6 ) \\ where k = 0 , 1 , … , ( \frac{N}{2} ) - 1. & \end{matrix}$$

The results may also be expressed as:

$$\begin{matrix}\begin{matrix}Y ( k ) = DFT [ x ( 2 p ) + jx ( 2 p + 1 ) ] , where p = 0 , 1 , … , ( \frac{N}{2} ) - 1 \\ = DFT [ {x}_{e} ( n ) + {jx}_{o} ( n ) ] \\ = DFT [ {x}_{e} ( n ) ] + jDFT [ {x}_{o} ( n ) ] or ,\end{matrix} & ( 7 ) \\ Y ( k ) = {X}_{e} ( k ) + {jX}_{o} ( k ) . & ( 8 )\end{matrix}$$

However, for performing the DIT radix-2 FFT, the output needed may be expressed as:

$$\begin{matrix}X ( i ) = {X}_{e} ( i ) + {W}_{N}^{i} * {X}_{o} ( i ) , & ( 9 ) \\ where & \\ {X}_{e} ( i ) = \frac{1}{2} [ Y ( i ) + {Y}^{*} ( \frac{N}{2} - i ) ] , & ( 10 ) \\ and & \\ {X}_{o} ( i ) = - \frac{j}{2} [ Y ( i ) - {Y}^{*} ( \frac{N}{2} - i ) ] . & ( 11 )\end{matrix}$$

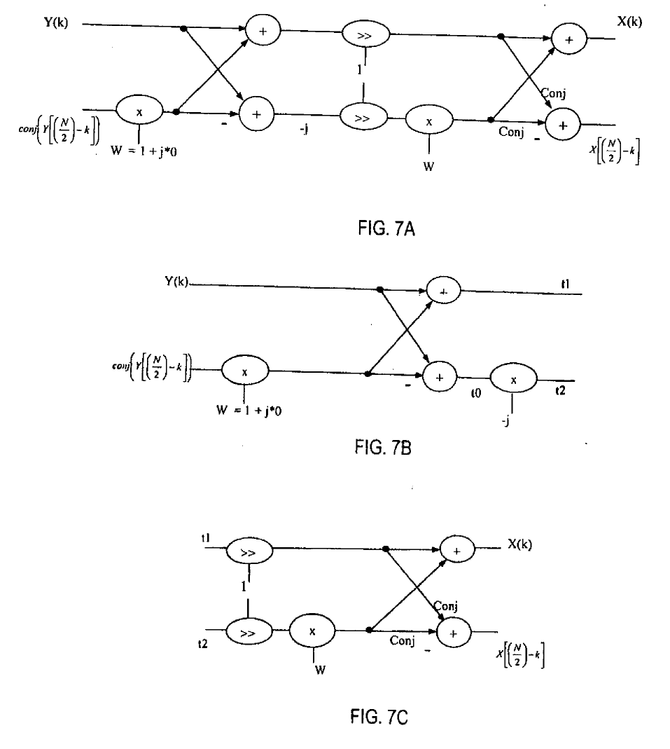

The needed output, X(i), may be generated by performing the post-processing block 510. FIG. 7A illustrates an exemplary functional block diagram for performing the post-processing block 510 in terms of butterfly operations according to an embodiment of the disclosure. It can be seen that the post-processing block 510 shown in FIG. 7A may be performed in two butterfly operations.

FIG. 7B illustrates a first butterfly operation for performing the post-processing block 510 according to an embodiment of the disclosure. As shown in FIG. 7B, the inputs to the first butterfly operation are Y(i) and the complex conjugate of

$$Y ( \frac{N}{2} - i ) , or {Y}^{*} ( \frac{N}{2} - i ) ,$$

with the twiddle factor W=1+j*0. Therefore, the twiddle factor of the first butterfly operation simply performs a multiplication by one. An output of the subtraction operation, t0, may be multiplied by negative j. For example, if t0=a+jb, then t2=j*t0=b−ja. So, the multiplication by negative j simply rearranges the real and imaginary parts of to differently in t2. The real part of to is negated and stored as the imaginary part of t2, and the imaginary part of t0 is stored as the real part in t2. The outputs of the first butterfly operation are:

$$\begin{matrix}t 1 = Y ( i ) + {Y}^{*} ( \frac{N}{2} - i ) & ( 12 ) \\ t 2 = - {j}^{*} \{ Y ( i ) - {Y}^{*} ( \frac{N}{2} - i ) \} . & ( 13 )\end{matrix}$$

### The butterfly processor 126 may store the outputs of the butterfly operation in the buffer 124 at the locations from which the inputs were read from.

FIG. 7C illustrates a second butterfly operation for performing the post-processing block 510 according to an embodiment of the disclosure. As shown in FIG. 7C, the inputs to the second butterfly operation are t1 and t2, calculated above, with the twiddle factor W=W_{N}ⁱ=e^{-j2πi/N}. Also, the second butterfly operation includes a symbol [symbol] for each of the inputs to the second butterfly operation. The symbol [symbol] represents an operation to shift the inputs to the right by one bit to perform a divide-by-two operation. The butterfly processor 126 may perform the divide-by-two operation using the scaling unit 412. The outputs of the second butterfly operation are:

$$\begin{matrix}X ( i ) = \frac{1}{2} [ Y ( i ) + {Y}^{*} ( \frac{N}{2} - i ) ] - \frac{j {W}_{N}^{i}}{2} [ Y ( i ) - {Y}^{*} ( \frac{N}{2} - i ) ] & ( 14 ) \\ and & \\ X ( \frac{N}{2} - i ) = \frac{1}{2} [ Y ( i ) + {Y}^{*} ( \frac{N}{2} - i ) ] + \frac{j {W}_{N}^{- i}}{2} [ Y ( i ) - {Y}^{*} ( \frac{N}{2} - i ) ] , & ( 15 )\end{matrix}$$

which are the desired outputs according to equations (9), (10), and (11). The butterfly processor 126 may store the outputs of the butterfly operation in the buffer 124 at the locations from which the inputs were read from. Therefore each of the stage 1 DIT radix-2 butterfly block 506 through the stage M DIT radix-2 butterfly block 508 and the post-processing block 510 of the FFT block 520 may be performed as a plurality of butterfly operations by the butterfly processor 126.

As described above in conjunction with FIG. 5B, the IFFT block 530 may be realized through a FFT using the pre-processing block 512. In the pre-processing block 512, the frequency domain data X(i) may be converted to a complex sum of Xₑ(i) and X₀(i), expressed as Y(k) in equation (8) above. The output of the pre-processing block 512, Y(k), may be input to the stage 1 DIT radix-2 butterfly block 506 through the stage M DIT radix-2 butterfly block 508.

The time domain output from the stage M DIT radix-2 butterfly block 508 in the IFFT block 530 may be expressed as:

$$\begin{matrix}x ( i ) = ifft ( {X}_{e} ( i ) + {jX}_{o} ( i ) ) & ( 16 ) \\ = {\sum }_{n = 0}^{\frac{N}{2} - 1} ( {X}_{e} ( i ) + {jX}_{o} ( i ) ) {W}_{\frac{N}{2}}^{- in} . & ( 17 )\end{matrix}$$

### Because x(i) is real, then x(i)=x*(i). Also, x₀(i)=x₀*(i) and xₑ(i)=xₑ*(i). Therefore,

$$\begin{matrix}x ( i ) = {\sum }_{n = 0}^{\frac{N}{2} - 1} {X}_{e} ( i ) {W}_{\frac{N}{2}}^{- in} + j {\sum }_{n = 0}^{\frac{N}{2} - 1} {X}_{o} ( i ) {W}_{\frac{N}{2}}^{- in} = {x}_{e} ( i ) + j {x}_{o} ( i ) & ( 18 ) \\ and & \\ x ( i ) = {x}_{e}^{*} ( i ) + j {x}_{o}^{*} ( i ) = {\sum }_{n = 0}^{\frac{N}{2} - 1} {( {X}_{e} ( i ) {W}_{\frac{N}{2}}^{- in} )}^{*} + j {{ }^{*} \sum }_{ n = 0}^{ \frac{N}{2} - 1} {( {X}_{o} ( i ) {W}_{\frac{N}{2}}^{- in} )}^{*} & ( 19 ) \\ \begin{matrix} = {\sum }_{n = 0}^{\frac{N}{2} - 1} ( {X}_{e}^{*} ( i ) {W}_{\frac{N}{2}}^{in} ) + {j}^{*} {\sum }_{n = 0}^{\frac{N}{2} - 1} ( {X}_{o}^{*} ( i ) {W}_{\frac{N}{2}}^{in} ) \\ = FFT ( {X}_{e}^{*} ( i ) + {jX}_{o}^{*} ( i ) ) .\end{matrix} & ( 20 )\end{matrix}$$

One skilled in the art will recognize that the equation (20) is similar to that of the FFT block 520 described above, such that the same twiddle factors that are used in the FFT block 520 may be used for the IFFT block 530. Therefore, the memory 414 may only need to store one set of twiddle factors for performing both FFT and IFFT operations.

The pre-processing block 512 may perform two butterfly operations to generate:

Y(i)=Xₑ^{*}(i)+jXₒ^{*}(i). (21)

### From equation (9),

$$\begin{matrix}X ( i ) = {X}_{e} ( i ) + {W}_{N}^{i} * {X}_{o} ( i ) , & \\ also , & \\ X ( \frac{N}{2} - i ) = {X}_{e}^{*} ( i ) - {W}_{N}^{{i}^{*}} * {X}_{o}^{*} ( i ) & ( 22 ) \\ and & \\ {X}^{*} ( \frac{N}{2} - i ) = {X}_{e} ( i ) - {W}_{N}^{i} * {X}_{o} ( i ) , & ( 23 ) \\ where & \\ {X}_{e} ( i ) = \frac{1}{2} [ X ( i ) + {X}^{*} ( \frac{N}{2} - i ) ] & ( 24 ) \\ and & \\ {X}_{o} ( i ) = \frac{1}{2 {W}_{N}^{i}} [ X ( i ) - {X}^{*} ( \frac{N}{2} - i ) ] . & ( 25 )\end{matrix}$$

### Therefore, Y(i) may be computed using equations (21)-(25) as

$$Y ( i ) = {X}_{e}^{*} ( i ) + j {X}_{o}^{*} ( i ) for i = 1 , … , \frac{N}{2} - 1 ( except for \frac{N}{4} ) \qquad ( 26 )$$

From the post-processing operation, it can be seen that

$$\begin{matrix}X ( \frac{N}{2} ) = Re [ Y ( 0 ) ] - Im [ Y ( 0 ) ] & ( 27 ) \\ and & \\ X ( 0 ) = Re [ Y ( 0 ) ] + Im [ Y ( 0 ) ] . & ( 28 ) \\ Therefore , & \\ Y ( 0 ) = \frac{1}{2} [ X ( 0 ) + X ( \frac{N}{2} ) ] + \frac{j}{2} [ X ( 0 ) - X ( \frac{N}{2} ) ] & ( 29 ) \\ and & \\ Y ( \frac{N}{4} ) = {X}^{*} ( \frac{N}{4} ) & ( 30 ) \\ and & \\ Y ( \frac{N}{2} - i ) = {X}_{e}^{*} ( \frac{N}{2} - i ) + j * {X}_{o}^{*} ( \frac{N}{2} - i ) = {X}_{e} ( i ) + j * {X}_{o} ( i ) . & ( 31 )\end{matrix}$$

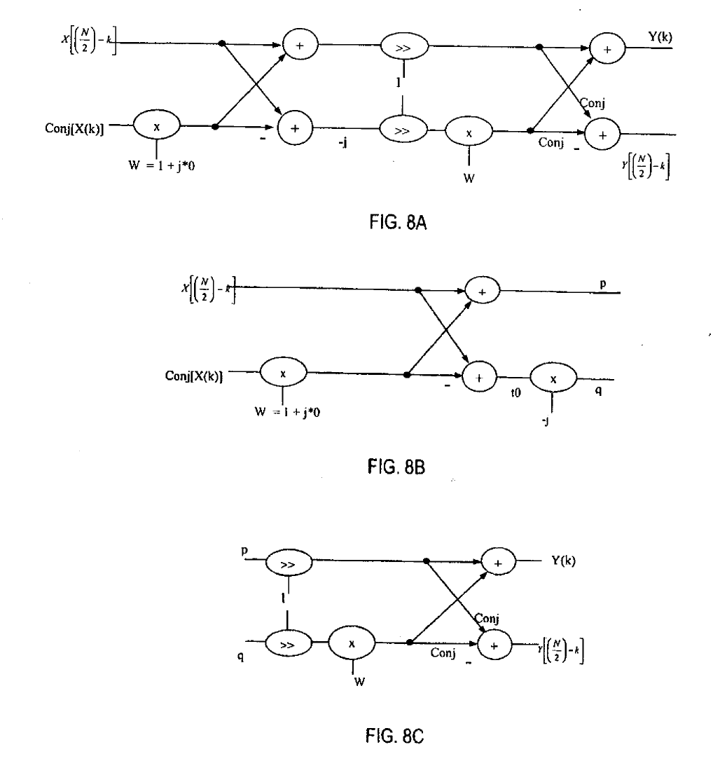

FIG. 8A illustrates an exemplary functional block diagram for performing the pre-processing block 512 in terms of butterfly operations according to an embodiment of the disclosure. As shown in FIG. 8A, the pre-processing block 512 computes Y(i) using equations (21), (24), and (25). It can be seen that the pre-processing block 512 shown in FIG. 8A may be performed in two butterfly operations.

FIG. 8B illustrates a first butterfly operation for performing the pre-processing block 512 according to an embodiment of the disclosure. As shown in FIG. 8B, the inputs to the first butterfly operation are X(i) and the complex conjugate of

$$X ( \frac{N}{2} - i ) ,$$

with the twiddle factor W=1+j*0. Therefore, the twiddle factor of the first butterfly operation simply performs a multiplication by one. An output of the subtraction operation, t0, may be multiplied by negative j. For example, if t0=a+jb, then q=−j*t0=b−ja. So, the multiplication by negative j simply rearranges the real and imaginary parts of t0 differently in q. The real part of t0 is negated and stored as the imaginary part of q, and the imaginary part of t0 is stored as the real part in q. The outputs of the first butterfly operation are:

$$\begin{matrix}p = X ( \frac{N}{2} - i ) + {X}^{*} ( i ) & ( 32 ) \\ and & \\ q = - j * \{ X ( \frac{N}{2} - i ) - {X}^{*} ( i ) \} . & ( 33 )\end{matrix}$$

### The butterfly processor 126 may store the outputs of the butterfly operation in the buffer 124 at the locations from which the inputs were read from.

FIG. 8C illustrates a second butterfly operation for performing the preprocessing block 512 according to an embodiment of the disclosure. As shown in FIG. 8C, the inputs to the second butterfly operation are p and q, calculated above, with the twiddle factor W=W_{N}ⁱ=e^{-j2πi/N}. Also, the second butterfly operation includes a symbol [symbol] for each of the inputs to the second butterfly operation. The symbol [symbol] represents an operation to shift the inputs to the right by one bit to perform a divide-by-two operation. The butterfly processor 126 may perform the divide-by-two operation using the scaling unit 412. The outputs of the second butterfly operation are:

$$\begin{matrix} Y ( i ) = \frac{1}{2} [ {X}^{*} ( i ) + X ( \frac{N}{2} - i ) ] + \frac{j}{2 {W}_{N}^{- i}} [ {X}^{*} ( i ) - X ( \frac{N}{2} - i ) ] & ( 34 ) \\ and & \\ Y ( \frac{N}{2} - i ) = \frac{1}{2} [ X ( i ) + {X}^{*} ( \frac{N}{2} - i ) ] + \frac{j}{2 {W}_{N}^{i}} [ X ( i ) - {X}^{*} ( \frac{N}{2} - i ) ] , & ( 35 )\end{matrix}$$

which are the desired outputs according to equations (21), (24), and (25). The butterfly processor 126 may store the outputs of the butterfly operation in the buffer 124 at the locations from which the inputs were read from. Therefore the pre-processing block 512 and each of the stage 1 DIT radix-2 butterfly block 506 through the stage M DIT radix-2 butterfly block 508 of the IFFT block 530 may be performed as a plurality of butterfly operations by the butterfly processor 126.

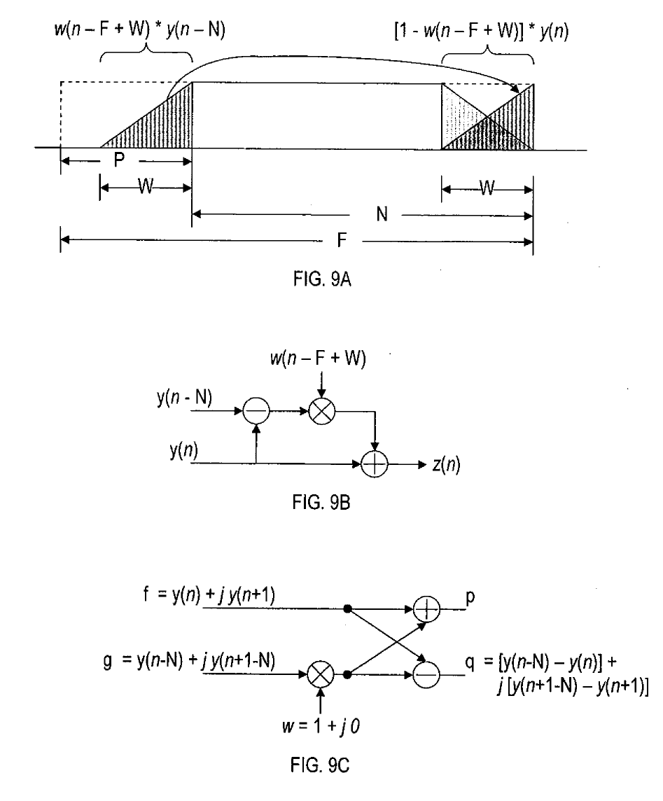

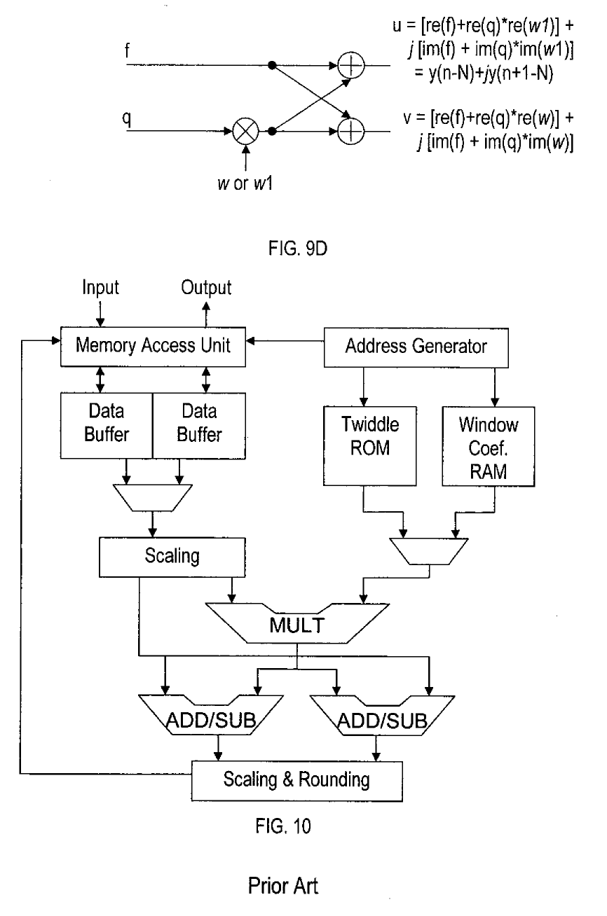

As shown in FIGS. 5A and 5B, each of the FFT block 520 and the IFFT block 530 may be performed in conjunction with the time domain windowing block 502. FIG. 9A illustrates a time domain windowing operation according to an embodiment of the disclosure. Similar to the pre-processing block 512 and the post-processing block 510, the time domain windowing block 502 may be performed using butterfly operations. If an input data frame y(n) has a first P samples as a cyclic prefix, then

y(n)=y(F−P+n) (36)

for n=0, 1, . . . , P-1 where F is a discreet multi-tone transceiver (DMT) frame length, N is a real FFT length, P is a cyclic prefix length, and W is a number of window coefficients. As shown in FIG. 9A, F=N+P, where N includes W samples. The time domain windowing operation shown in FIG. 9A leaves the first F−W samples unchanged, where the first F−W samples may include y(0), . . . , y(F−W−1). The last W samples may be computed as z(n), where

$$\begin{matrix}z ( n ) = w ( n - F + W ) * y ( n - N ) + [ 1 - w ( n - F + W ) ] * y ( n ) & ( 37 ) \\ = y ( n ) + w ( n - F + W ) * [ y ( n - N ) - y ( n ) ] & ( 38 ) \\ for n = F - W , … , F - 1. & \end{matrix}$$

FIG. 9B illustrates an exemplary functional block diagram for performing the time domain windowing block 502 in terms of butterfly operations according to an embodiment of the disclosure. As shown in FIG. 9B, the time domain windowing block 502 computes z(n) using equation (38). The multiplication factor w(n−F+W) in equation (37) and equation (38) may be a window coefficient vector. The computation for the time domain windowing block 502 shown in FIG. 9B may be performed in two butterfly operations.

FIG. 9C illustrates a first butterfly operation for performing the time domain windowing block 502 according to an embodiment of the disclosure. As shown in FIG. 9C, the using butterfly operations, the time domain windowing operation may be performed on two samples at a time. A first input, f, may be a complex sum of even and odd samples of y(n). Similarly, a second input, g, may be a complex sum of even and odd samples of y(n−N). The window coefficient in the first butterfly operation may be w=1+j*0. Therefore, the window coefficient of the first butterfly operation simply performs a multiplication by one. The outputs of the first butterfly operation are:

p=[y(n−N)+y(n)]+j[y(n+1−N)+y(n+1)] (39)

and

q=[y(n−N)−y(n)]j[y(n+1−N)−y(n+1)]. (40)

The butterfly processor 126 may store the outputs of the butterfly operation in the buffer 124 at the locations from which the inputs were read from. While p is generated as part of the first butterfly operation, the output p may not be stored in the location of f.

FIG. 9D illustrates a second butterfly operation for performing the time domain windowing block 502 according to an embodiment of the disclosure. As shown in FIG. 9D, the inputs to the second butterfly operation are f and the value of q calculated above in equation (40). The window coefficient of the second butterfly operation may be selected based on the computation of the required output u or v. The selection of the window coefficient may be done by the address generator 404 generating the appropriate address to the window coefficient RAM 416 in FIG. 4. The outputs of the second butterfly operation are:

$$\begin{matrix}\begin{matrix}u = [ re ( f ) + re ( q ) * re ( w 1 ) ] + j * [ im ( f ) + im ( q ) * im ( w 1 ) ] \\ = y ( n - N ) + j * y ( n + 1 - N ) , where w 1 = 1 + j 1\end{matrix} & ( 41 ) \\ and & \\ \begin{matrix}v = [ re ( f ) + re ( q ) * re ( w ) ] + j * [ im ( f ) + im ( q ) * im ( w ) ] , \\ where w = w ( i ) + j w ( i + 1 )\end{matrix} & ( 42 )\end{matrix}$$

which is the desired output according to equation (38). The output u may be stored in the location of q to restore the contents of the input g. As mentioned above, the output v is the desired result and may be stored in the location of f. Therefore the time domain windowing block 502 may also be performed as a plurality of butterfly operations by the butterfly processor 126.

As described above, each of the time domain windowing, FFT, and IFFT operations may be performed in terms of butterfly operations by the butterfly processor 126. Each butterfly operation may be performed by the butterfly processor 126 in four clock cycles. Each butterfly operation may be preceded by two read operations to read the inputs from the buffer 124 and followed by two write operations to write the outputs to the buffer 124. When performing the FFT or the IFFT operations, the butterfly processor 126 may compute the result in 4*M*(N/4) clock cycles for each of the stage 1 DIT radix-2 butterfly block 506 through the stage M DIT radix-2 butterfly block 508. Also, the butterfly processor 126 may perform the bit reversal block 504 in 4*N/2 clock cycles.

Each of the pre-processing block 512, the post-processing block 510, and the time domain windowing block 502 may be performed in two butterfly operations. The butterfly processor 126 may perform each of the pre-processing block 512, the post-processing block 510, and the time domain windowing block 502 in 4*2*(N/4) clock cycles. Therefore each of the processing sequences depicted in FIGS. 5A and 5B may take a total of 4*(M+4)*(N/4) clock cycles.

In an implementation of the butterfly processor 126, such as that shown in FIG. 1, additional clock cycles greater than or equal to around N/2 clock cycles may be needed for transferring data from the buffer to the other processing 102. If the frame frequency rate is F kHz, then the clock frequency may be greater than or equal to around F*[(M+4)*N+(N/2)] kHz. For N=1024, the frequency may be around 55 MHz. Higher frequencies may be necessary depending on the arbitration at the buffer and at the memory in the other processing 102.

The butterfly processor 126 may be implemented in 90 nm 1.1V CMOS technology to perform 64-4096 point FFT/IFFT/windowing operations within around 183 us and consume around 19.8 mW of dynamic power for the largest size. The butterfly processor 126 may be implemented into the physical layer blocks of a VDSL2 transceiver or other communication device and occupy an area of 0.38 sqmm. Therefore, the architecture of the butterfly processor 126 may be comparable to that of other known architectures and may match the throughput of pipelined architectures at the same latency.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented. For example, while only a single butterfly processor 126 is shown in the implementation of FIG. 1, persons of ordinary skill in the art will recognize that a plurality of the butterfly processors 126 may be included to operate concurrently or pipelined in sequence to process different portions of input data for performing windowing/IFFT/FFT operations.

Also, techniques, systems, subsystems and methods described and illustrated in the various embodiments as discrete or separate may be combined or integrated with other systems, modules, techniques, or methods without departing from the scope of the disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A system comprising:
a memory; and
a processor configured to perform multiple iterations of in-place decimation-in-time radix-2 butterfly operations on a sequence of input data to execute one of a plurality of signal processing operations including a fast Fourier transform and inverse fast Fourier transform,
wherein for each of the multiple iterations, the processor receives a first input from a first location in the memory and receives a second input from a second location in the memory and performs a radix-2 butterfly operation of the first input and the second input to generate a first output and a second output, the first output is stored in the first location in the memory and the second output is stored in the second location in the memory.

2. The system of claim 1, wherein the processor comprises:
a multiplier configured to receive the second input and a multiplication factor and generate a third output as a product of the second input and the multiplication factor;
an adder configured to receive the first input and the third output and generate the first output as a sum of the first input and the third output; and
a subtracter configured to receive the first input and the third output and generate the second output as a difference between the first input and the third output.

3. The system of claim 2, wherein the multiplication factor is one of a plurality of twiddle factors expressed as W_{N}ⁱ=e^{-j2πi/N}, where i is an integer and N is a number of real samples in the sequence of input data.

4. The system of claim 3, wherein the same twiddle factors are used in executing the fast Fourier transform and the inverse fast Fourier transform.

5. The system of claim 1, wherein the first input is a complex sum of two real numbers in the sequence of input data, and
wherein the second input is a complex sum of another two real numbers in the sequence of input data.

6. The system of claim 1, wherein the first input and the second input each a complex sum of even numbers in the sequence of input data and odd numbers in the sequence of input data.

7. The system of claim 1, wherein the signal processing operation is the inverse fast Fourier transform,
wherein the sequence of data is a sequence of frequency domain data;
wherein the frequency domain data is expressed as:
X(i)=Xₑ(i)+W_{N}ⁱ*Xₒ(i), where i is an integer, X(i) is the sequence of frequency domain data, Xₑ(i) is even data in the sequence of frequency domain data, W_{N}ⁱ=e^{-j2πi/N} is a twiddle factor, N is a number of samples of data in the sequence of frequency domain data, and Xₒ(i) is odd data in the sequence of frequency domain data, and
wherein a first two of the multiple iterations transforms the sequence of frequency domain data to a format expressed as:
Y(i)=Xₑ^{*}(i)+jXₒ^{*}(i), where Y(i) is the transformed sequence of frequency domain data, Xₑ^{*}(i) is the complex conjugate of even data in the sequence of frequency domain data, j is a representation of an imaginary number \sqrt{−1}, and Xₒ^{*}(i) is the complex conjugate of odd data in the sequence of frequency domain data.

8. The system of claim 7, wherein M stages of decimation-in-time radix-2 butterfly operations are performed subsequent to the first two of the multiple iterations,
wherein
$$M - {log}_{2} ( \frac{N}{2} ) , and$$
wherein each of the M stages includes N/4 iterations of decimation-in-time radix-2 butterfly operations.

9. A method of performing an inverse fast Fourier transform, comprising:
executing a pre-processing operation on a sequence of frequency domain data, wherein the frequency domain data is expressed as:
X(i)=Xₑ(i)+W_{N}ⁱ*Xₒ(i), where i is an integer, X(i) is the sequence of frequency domain data, Xₑ(i) is even data in the sequence of frequency domain data, W_{N}^{l =e}^{-j2πi/N} is a twiddle factor, N is a number of samples of data in the sequence of frequency domain data, and Xₒ(i) is odd data in the sequence of frequency domain data, and
wherein the pre-processing operation transforms the sequence of frequency domain data to a format expressed as:
Y(i)=Xₑ^{*}(i)+jXₒ^{*}(i), where Y(i) is the transformed sequence of frequency domain data, Xₑ^{*}(i) is the complex conjugate of even data in the sequence of frequency domain data, j is a representation of an imaginary number \sqrt{−1} and Xₒ^{*}(i) is the complex conjugate of odd data in the sequence of frequency domain data;
executing a fast Fourier transform on the transformed sequence of frequency domain data to generate the inverse fast Fourier transform of the sequence of frequency domain data; and
storing the inverse fast Fourier transform.

10. The method of claim 9, wherein executing the fast Fourier transform includes executing M stages of in-place butterfly operations, where
$$M - {log}_{2} ( \frac{N}{2} ) ,$$
and each of the M stages includes N/4 decimation-in-time radix-2 butterfly operations.

11. The method of claim 10, wherein each decimation-in-time radix-2 butterfly operation comprises:
multiplying a first input by a twiddle factor to generate a first output;
adding a second input with the first output to generate a second output; and
subtracting the first output from the second input to generate a third output.

12. The method of claim 11, wherein each decimation-in-time radix-2 butterfly operation further comprises:
generating the first input and the second input as a complex sum of even numbers in the sequence of frequency domain data and odd numbers in the sequence of frequency domain data.

13. The method of claim 11, wherein the first input is read from a first address and the second input is read from a second address, and
wherein the second output overwrites the first input in the first address and the third output overwrites the second input in the second address.

14. The method of claim 9, wherein the pre-processing operation comprises:
executing a first butterfly operation, wherein the first butterfly operation comprises:
multiplying a complex conjugate of
$$X ( \frac{N}{2} - i )$$
by one to generate a first output;
adding X(i) with the first output to generate a second output; and
subtracting X(i) from the second input to generate a third output.

15. The method of claim 14, wherein the pre-processing operation further comprises:
executing a second butterfly operation, wherein the second butterfly operation comprises:
multiplying the second output by −j, where j is a representation of an imaginary number \sqrt{−1}, to generate a fourth output;
adding the third output with the fourth output to generate Y(i); and
subtracting the fourth output from the third output to generate
$$Y ( \frac{N}{2} - i ) .$$

16. The method of claim 15, further comprising:
overwriting X(i) with the second output;
overwriting
$$X ( \frac{N}{2} - i )$$
with the third output;
overwriting the second output with Y(i); and
overwriting the third output with
$$Y ( \frac{N}{2} - i ) .$$

17. A signal processor, comprising:
a multiplier configured to multiply first inputs to the signal processor with a multiplication factor to generate a first output;
an adder configured to add second inputs to the signal processor with the first output to generate a second output; and
a subtracter configured to subtract the first output from the second inputs to generate a third output,
wherein the signal processor executes one of a plurality of signal processing operations including a fast Fourier transform, an inverse fast Fourier transform, and a time domain windowing utilizing the multiplier, the adder, and the subtracter.

18. The signal processor of claim 17, wherein the signal processing operation is the inverse fast Fourier transform,
wherein the signal processor executes the inverse fast Fourier transform with a first operation utilizing the multiplier, the adder, and the subtracter, wherein the first operation comprises:
multiplying the first inputs by one to generate first outputs;
adding the second inputs with the first output to generate second outputs;
subtracting the first outputs from the second inputs to generate third outputs;
overwriting the first inputs with the third outputs; and
overwriting the second inputs with the second outputs.

19. The method of claim 18, wherein the signal processor further executes the inverse fast Fourier transform with a second operation utilizing the multiplier, the adder, and the subtracter, wherein the second operation comprises:
multiplying the second outputs by −j, where j is a representation of an imaginary number \sqrt{−1}, to generate fourth outputs;
adding the second outputs with the fourth output to generate fifth outputs; and
subtracting the fourth outputs from the third output to generate sixth outputs.

20. The method of claim 19, wherein the signal processor further executes the inverse fast Fourier transform with M operations utilizing the multiplier, the adder, and the subtracter, where
$$M - {log}_{2} ( \frac{N}{2} ) ,$$
a number of the first inputs is x, a number of the second inputs is y, and N is twice the sum of x and y, wherein each of the M operations comprises:
multiplying a first input from a preceding operation by one of a plurality of twiddle factors corresponding to a current operation to generate a first output of the current operation;
adding a second input from the preceding operation with the first output of the current operation to generate a second output of the current operation;
subtracting the first output of the current operation from the second input from the preceding operation to generate a third output of the current operation;
overwriting the first input from the preceding operation with the third output of the current operation; and
overwriting the second input from the preceding operation with the second output of the current operation,
wherein the second output of the current operation is the first input from a preceding operation for a subsequent operation and the third output of the current operation is the second input from a preceding operation for the subsequent operation.
